(19) United States
(12) Patent Application Publication
(10) Pub. No.: US 2010/0279718 A1
(43) Pub. Date: Nov. 4, 2010

(54) TELEMEDICINE CARE

(75) Inventor: Alexander Borve, Goteborg (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: IDOC24 AB, Kista (SE)

(21) Appl. No.: 12/739,021

(22) PCT Filed: Oct. 21, 2008
(86) PCT No.: PCT/SE2008/051186

§ 371 Date: Jun. 24, 2010

(30) Foreign Application Priority Data
Oct. 22, 2007 (US) 60999820
Oct. 22, 2007 (US) 60999821

(51) Int. Cl. H04W 4/12

(52) U.S. Cl. 455/466

(57) ABSTRACT

The present invention relates to a system, device and a method for communicating medical information using a mobile telephone with a digital camera. A technical solution for safe, secure, convenient and rapid diagnostic service in Tele-Medicine has been developed. The invention uses digital images as a medium for diagnostics in health care transmitted by a mobile telephone using Multimedia Messaging Service (MMS). The invention relates particularly to the fields of medicine, where a health worker can from an image give a diagnosis, treatment recommendations, recommendation for further analysis, triage or if the patient needs to see a health worker face to face.

### TECHNICAL FIELD

The present invention relates to a system for efficiently communicating status of a patient in need of care to care persons located at a site different from that of the patient.

### BACKGROUND OF THE INVENTION

Due to the on going work of streamlining care services, for example hospital and trauma care there is a need for developing applications that can help care workers in their work to provide higher quality and higher availability at a reduced cost. Care service may be provided in many ways that are different from the traditional patient and care person interaction. For example, not all medical conditions necessarily require that the medically skilled person is physically present in order to give a diagnosis or advice. The medical condition may be of a nature that it is not in need of immediate treatment, or it is questionable whether the condition needs medical attention at all. In other situations it is of uttermost importance that medically skilled personnel are able to understand a situation, make a decision or give advice as soon as possible in order to save lives.

With today's technology you can send a digital photograph of high quality with a mobile telephone which has a digital camera, the image sent is called a Multimedia Messaging Service (MMS). With a digital camera, one may take a good quality photo of a situation or a medical condition of interest and send it from a mobile phone as an MMS, together with relevant information concerning the circumstances (i.e. situation and/or medical condition) to a medically skilled person for consultation.

### SUMMARY OF THE INVENTION

The present invention relates to a technical solution for safe, secure, convenient and rapid diagnostic service in Tele-Medicine anywhere in the world where a mobile telephone network exists. The invention can be applied to all areas of “visual” medicine, where a doctor uses images with patient history for diagnostics such as dermatology, venereology, pathology, radiology, trauma opthalmology, ear, nose and throat diseases. The invention takes advantage of MMS technique that can relay large enough volumes of data from a mobile telephone over the mobile telephone networks. A mobile telephone with a digital camera is used to transmit a visual medical question from a person to a qualified professional health worker. The person receives a unique randomised errand number related to each unique MMS and can remain anonymous so that no patient health worker is established. The person receives first hand medical information related to the query once the health worker has looked at the MMS. The medical information includes a possible diagnosis, treatment recommendations when/or if the patient should consult a health worker in person.

The person that has a visual medical query will use a mobile telephone with an inbuilt digital camera. The person will take a quality picture of the medical concern, write a brief history about the concern including any symptoms, duration, medication, exposure, medication, sex and age. The MMS is sent to a defined telephone number that is connected to the system. When the system receives the MMS a confirmation short message service (SMS) is sent to the sending mobile telephone which includes an errand number. As soon as possible within 24 hours the person receives medical information related to the query and the case is completed. The person remains anonymous as no incoming telephone number is saved and the person can if wishes identify the case number in the future with the errand number.

The application can also be used in other fields of medical or foreign office triage. A citizen can send a MMS to authorities and use the MMS information for triage and resource saving purposes. For example at the scene of a traffic accident an image can help the emergency operator to dispatch the right resources at the right time if the person calling the emergency operator sends a MMS too. An image complements the verbal description of the scene of the accident and can help optimising the help sent to the scene of the accident.

In particular the invention relates to a system which facilitates communication when diagnosing skin conditions, comprising:

a server arranged to receive a multimedia message, MMS, from a mobile phone and to store the MMS file in a database;
an operator interface in communication with the server, arranged to provide access to the database and to receive diagnosis information from an operator relating to the stored MMS file; wherein the server is further arranged to transmit a short message back to the mobile phone with the information received from the operator.

In another embodiment of the invention the server is further arranged to provide charging of transmittal of short message back to the mobile phone.

In another embodiment of the invention the server is further arranged to receive information about the user of the mobile phone.

In yet another embodiment of the invention the information about the user comprise at least one of a unique errand number, a name, address, and a social security number.

Furthermore the invention also relates to a method for handling communication of skin condition diagnosis, comprising the steps of:

receiving in a server from a mobile phone a multimedia message, MMS, with at least one image of a skin condition to be diagnosed;
storing the MMS in a database;
providing anonymity for the client using a unique errand number for every unique MMS; providing access to the database for a medical staff;
receiving on a user interface a diagnosis from the medical staff relating to the skin condition;
storing the diagnosis in the server;
transmitting a message relating to the diagnosis back to the mobile phone.

In another embodiment of the invention a prescription relating to the skin condition is transmitted to a pharmacy together with information relating to a user of the mobile phone.

In another embodiment of the invention the information relating to the user is at least one of a unique errand number, a name, address, and a social security number.

In another embodiment of the invention the mobile phone is charged for the transmittal of a message relating to the diagnosis.

The present invention also describes a device for facilitating communication when diagnosing a skin condition, comprising:

a processor;
a memory; and
a communication interface;
wherein the processor is arranged to receive on the communication interface from a mobile phone a multimedia message, MMS, with at least one image of a skin condition to be diagnosed, storing the MMS in a database in the memory, returning a SMS to the sender with a unique random errand number for every unique MMS, providing access to the database, and to receive diagnosis information from an operator relating to the stored MMS file, wherein the processor is further arranged to transmit on the communication interface a short message or multimedia message back to the mobile phone with the information received from the operator.

### DEFINITIONS

Tele-medicine is defined as medicine from a distance.

Tele-dermatology is ‘skin from a distance’.

### BRIEF DESCRIPTION OF THE DRAWINGS

FIG. 1 illustrates a system and system architecture according to the present invention in general terms;

FIG. 2 illustrates a system and system architecture according to a first embodiment of the present invention;

FIG. 3 illustrates schematically a typical use of the first embodiment of the present invention in general terms;

FIG. 4 illustrates schematically a system and system architecture according to a second embodiment of the present invention; and

FIG. 5 illustrates schematically a typical use of the second embodiment of the present invention.

### DETAILED DESCRIPTION OF PREFERRED EMBODIMENTS

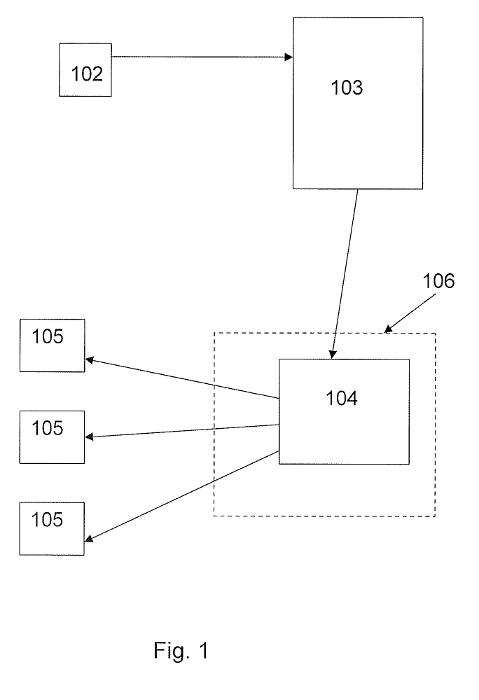

FIG. 1 generally illustrates a system and system architecture according to the present invention: A system may comprise a mobile phone (102), a communication infrastructure network (103), at least one information handling server (104) and at least one user access terminal (105). The mobile telephone (102) e.g. a GSM, GPRS, 3G (Europe) or (W)CDMA (USA) compatible phone often have high quality digital cameras. Preferably one may use a mobile phone equipped with a digital camera with at least 1.3 MB of pixel information. The size of a Multimedia Messaging Service (MMS) can vary depending on the picture size, the mobile telephone used and the conditions the operator enforces on the size of an MMS. In general the size of an MMS is more than 10 kB.

The communication infrastructure network (103) may comprise an access gateway (e.g. a base station) of an operator, communication infrastructure devices in an infrastructure network (comprising e.g. GGSN, SGSN, RNC, BSS, and so on depending on type of network as understood by the skilled person), a multimedia server, e.g. an MMS server, or a mail server or an Uniform Resource Locator (URL) server.

The information handling server (104) may be a dedicated optionally secure server provided with security measures (106) such as virus protection, firewall protection and encryption in order to protect stored information.

The handling server (105) may be arranged with facilities to store information related to multimedia information received.

The system is arranged to communicate between a sender and a recipient in order to provide services to the sender or the recipient (optionally for a fee) using multimedia messaging. These services include medical information or official information. Medical information may comprise medical diagnosis, advice and treatment information which is based on multimedia information transferred using multimedia communication protocols.

The following two examples describe two different situations wherein the present invention may be implemented.

### Example 1

### Tele-diagnosis

The system may be implemented as an (optionally) anonymous healthcare information service where a patient in need of medical consultation may send an MMS, i.e. a photo of the medical condition together with a description of the relevant circumstances to a web service. Preferably the medical condition is a visual condition such as for example skin lesions, skin rashes, eczema, spots, intimate skin concerns, skin bumps, visual eye concern, visual mouth concerns, visual ear concern and other visual body concerns. The MMS is received and examined by trained medical staff e.g. registered doctors with expertise in general medicine or skin & venereal medicine and the medical information is given by the same medical staff. The system offers firsthand medical information to the patient on the possible diagnosis and recommended treatments, or if the patient should consult a GP in person.

Preferably a digital camera with at least 1.3 MB of pixel information is used for taking photos. Advantageously there is good light in the surroundings when the photo is taken. Natural daylight is the best form of light; however, other light conditions may be used. In order to get a representative picture one may take several pictures and select the best one or include additional pictures depending on the size of the MMS.

With the digital camera, one takes good quality photographs that best represent the medical condition of interest and sends it/them from a mobile phone as an MMS, together with relevant information concerning the skin to a web service.

The additional information (types as text information for instance) does not have to be included but can be of great help to make the right diagnosis. This type of information may include, but is not limited to:
Age and/or Sex
time space: hours, days, weeks, moths, years or born with it
Contact, exposure: wind, sun, cold, water, washing up liquid, metal, animals etc
Where on the body?
Describe the symptoms: itchy, stings, pain
Fever?
Do you take medicines, which ones?
Others in your surroundings that have the same as you?
Have you had something similar before?
Have you had treatment for this before?
Known allergy? Which one?

This type of information may be included in text message appended to the media message. In order to help the client include all relevant information in the MMS a self explanatory digital form (optional) may be constructed and installed as an application on the client mobile telephone device. An MMS may be sent with all the relevant information together with the picture(s) via the application.

A dermatologist or a general practitioner (GP) with skin experience connects to the web service application, installed on a secure dedicated server, using the communications protocol Secure Sockets Layer (SSL). In order to serve as many users as possibly and to guarantee quick answers, the system may optionally use a web application wherein several medical staff, e.g. physicians, may be arranged to be connected as consulting party. This party may include dermatologists and general practitioners that judge the MMS. The medical staff may be located at any location where there is a network connection which enables cost efficient handling of inquiries and around the clock services.

The dermatologist, GP, or consulting party will inspect the picture and read the relevant text accompanying the picture(s). In the method visual changes are judged, for example: skin lesions, skin rashes, eczema, spots, intimate skin concerns, skin bumps, visual eye concern, visual mouth concerns, visual ear concern and other visual body concerns.

A written reply will be sent to the patient as a SMS or MMS as quickly as possible, with a probable diagnosis and recommendation on treatment preferably within a day. With a probable diagnosis one can also search the internet for more specific and in depth information on the subject.

A patient file is created, optionally with unique errand number, social security number, time stamp, doctor responsible, patient picture(s) and enclosed wording, doctor's diagnosis and possible treatment.

It should be noted that skin diseases are not always straight forward to diagnose even when consulting a GP or a skin specialist. Studies have shown that there is not 100% reliability when a skin specialist diagnoses a skin lesion without taking a sample of the skin lesion for a microscopic examination. The most feared skin lesion is malignant melanoma that is a very aggressive skin cancer. Early diagnosis is important as this lesion can be removed.

The system according to the present invention provides only a consultation service tool which cannot guarantee a 100% accurate diagnosis. When one sends an MMS one will receive a possible diagnosis and a recommended self treatment from connected medical staff, e.g. doctors.

The following method may be applied when using the system:
1. Take several pictures of the area of concern using a digital camera having a high resolution, preferably at least 1.3 MB of pixel information;
2. Choose the picture, or pictures that describes the problem best;
3. Type text of relevance in the MMS;
4. Send the MMS to a pre defined service number optionally with a prefix and space then text. Optionally an SMS with a confirmation may be returned to the sending number; and
5. Within a time limit (e.g. max 48 hours) an SMS or MMS with a probable diagnosis and treatment information or with a recommendation that one should seek a doctor in person for a more thorough analysis and diagnosis is received.

This method could also be compromised into a self explanatory digital form (optional) that has been pre installed as a mobile phone application on the patient's mobile.

MMS size limit is normally set by operators and may be for instance 300 kb (however, it should be understood by the skilled person that other sizes may be used depending on operator, type of phone etc.). Some mobile telephone models can not handle MMS with this size due to the internal memory of the phones. Some mobile telephones are restricted to send/receive MMS with max 40 kb others 100 kb etc.

By using paid services, such as premium MMS services, the sending party is debited a pre defined cost for the service and the party providing the service will receive payment for the consulting service.

For instance, every MMS sent that is received by the system is debited a predefined sum e.g. 50 SEK or 5 Euro on the monthly mobile telephone bill or from the prepaid account.

If the patient is not debited in anyway by the service provider, the system could be part of the National Health Service (NHS) as free medical advice service. The NHS and service provider can reach an agreement on how to finance the service. A possibility is that the service provider is reimbursed a fixed amount for every patient that does not need to see a doctor in person, because the patient could treat himself/herself from the advice information given.

An answer to the MMS inquiry may received within a pre defined time period, e.g. within 24 hours.

In the system consulting medical staff may prescribe medication but normally only medication such as creams and medicines concerning the skin will be prescribed.

If the user wants a prescription and is anonymous using the service he/she may send a new MMS from the same mobile telephone number, with his/hers unique errand number, social security number and the name of the medicine desired. The prescription may be sent by an E-prescription to a pharmacy and can be collected from any pharmacy, optionally for a fee. If the user is not anonymous to the medical staff, the prescription may be included directly together with the diagnosis.

The details of the inquiry may include: an errand number, a mobile phone number, social security number, MMS and SMS answers may be stored as a journal for a time period determined by the health authority law of respective country.

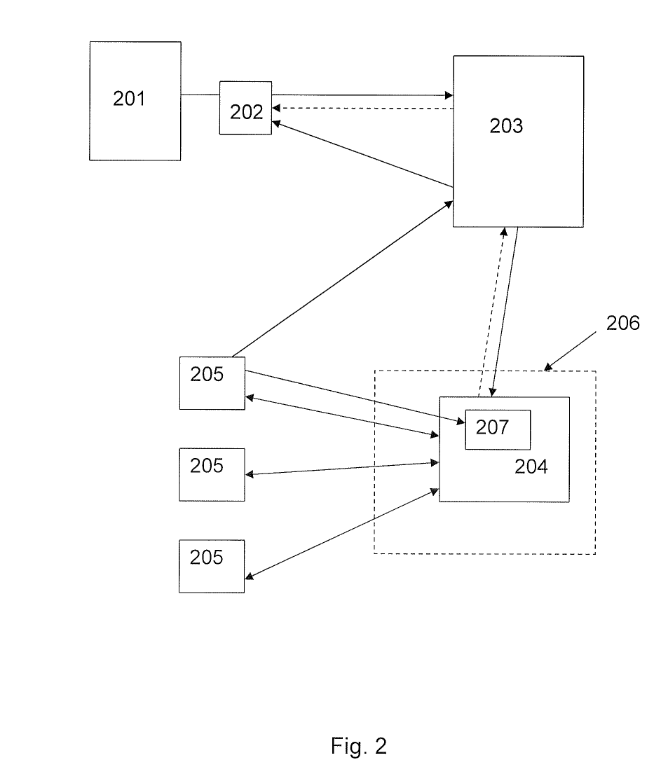

The operation of the system will now be discussed in more detail with respect to different parties in the system (see FIG. 2)
1. The patient (201) identifies visual medical concern on body.
2. The patient (201) uses a digital camera (202) and sends good quality picture(s) as a premium MMS from a mobile phone to a communication infrastructure network (203).
3. The system application (204) receives the MMS.
4. The patient receives a confirmation SMS with a unique errand number for this case, and a short message that a physician has been contacted and is attending to the case.
5. Optionally the patient is debited on telephone bill or directly if the mobile phone subscription is a cash subscription. If the system is reimbursed by the NHS, the patient is not debited.
6. A dermatologist or a GP) (205) with skin experience connects to the service application (204) installed on a secure dedicated server by the communications protocol Secure Sockets Layer (SSL) (206).
7. The dermatologist or GP (205) inspects the picture and reads the relevant text accompanying the picture.
8. The dermatologist or GP (205) replies to the MMS in a pre-written answer that can be modified to the specific patient within 24 hours.
9. The patient receives an SMS or MMS with medical information that includes a probable diagnosis and treatment information or if the patient should see a doctor face to face.
10. A patient file (207) is created to the unique errand number, optionally with time stamp, doctor responsible, patient picture and enclosed wording, doctor's diagnosis and possible treatment.
11. The patient can later use the probable diagnosis in internet search engines for self treatment.
12. The patient may also identify his consultation by referring to the unique errand number when in contact with the service provider. The service provider has the option to keep the client anonymous, thus deleting the client telephone number when the errand has been concluded. The medical staff can not trace the client.

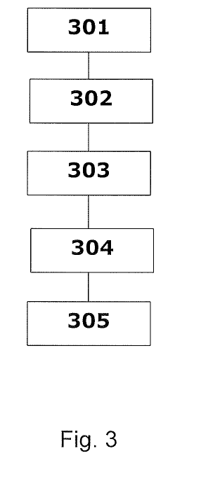

FIG. 3 illustrates schematically a typical use in general terms of the present invention.

301. Receiving an SMS, MMS, or multimedia message and optionally information related to the message (e.g. source telephone number or other address information, operator, all or part of AAA information (i.e. access, authorization, and accounting)) in a server using a predefined contact address, e.g. a telephone number or an unique errand number;
302. Optionally charging for the receipt of the message;
303. Determining how to handle the message: alerting about the existence of the message or sending the message to advice person;
304. Obtaining advice information from the advice person and storing this at least temporarily in the server.
305. Sending an answer to the source telephone number.

In another embodiment of the present invention, nationals being abroad may seek help from the foreign office (state department) of their home country using a similar solution, wherein
1. The system application is installed on the foreign office server.
2. Your operator needs to have established roaming contracts with respective country.
3. The application is programmed so that it will receive SMS, MMS or multimedia files from respective citizens travelling in foreign countries. Example: application installed in Sweden will only accept mobile numbers with “46” as country code and Norway only with “47” and so forth.
4. Citizen sends a message with the visiting countries name as a prefix with a text message. Example: if the person is in Iran, the prefix will be “Iran” or the national code or telephone number prefix with a description of problem, query or information. The foreign office can decide if this service should have a cost which is debited on respective mobile phone bill or if it is free of charge.
5. Foreign office sends an SMS or MMS for further instructions or contact locations for further help.

The foreign office can build a logistical database on who is where and in what condition etc. Part of the handling of the advice may be automated using the prefix information, e.g. using the country prefix information a first answer may be immediately returned stating the query is dealt with but for quick access to the local contact organization (for instance the embassy in the country of interest) contact data for the local organization may be added to the answer message.

### Example 2

### Tele-Trauma®

In another embodiment the present invention may be implemented as a tool for early communication between an accident scene, the emergency operator, rescue personnel and care persons at hospital. In the past and still today a Polaroid photo is taken of an accident, and is brought with the patient to the E.R. The information on this photo is often useless to the E.R staff once the patient is brought to the hospital as the patient itself is the focus at this point in time.

The present invention comprises a network (e.g. web) application wherein the purpose is to help prioritise relevant emergency resources to the scene of an accident, and thereafter prepare the emergency room (E.R) logistically and mentally for arriving trauma patients.

The network application is registered as Tele-Trauma®. In accordance with the present invention citizens that call the emergency operator from an accident scene can acquire a photo or some other multimedia information (e.g. a short video sequence) using the mobile phone and transmit this information as an MMS to the infrastructure network (e.g. the multimedia server or email server) which in turn send the information to a secure database server located for instance at the emergency operator or a hospital where the ambulance will arrive. The MMS complements verbal communication with an image for a better understanding of the accident. The operator can prioritise better and dispatch the right resources to the scene of the accident. The operator (optional) can then relay the MMS to the emergency workers on the way to the scene of the accident as well as to the E.R. The E.R staff is mentally and logistically prepared for the incoming injured patient. This can help to increase the possibility of a better outcome for the injured patient and see to that the right patients get all necessary resources at the right time. Studies have also shown that “scoop and run” gives the patient the best possibility of survival; you should not try and treat the patient at the scene of the accident, but immediately drive to the nearest hospital with surgical intervention possibilities. Therefore it is very important that the right resources arrive at the scene of the accident at the right time.

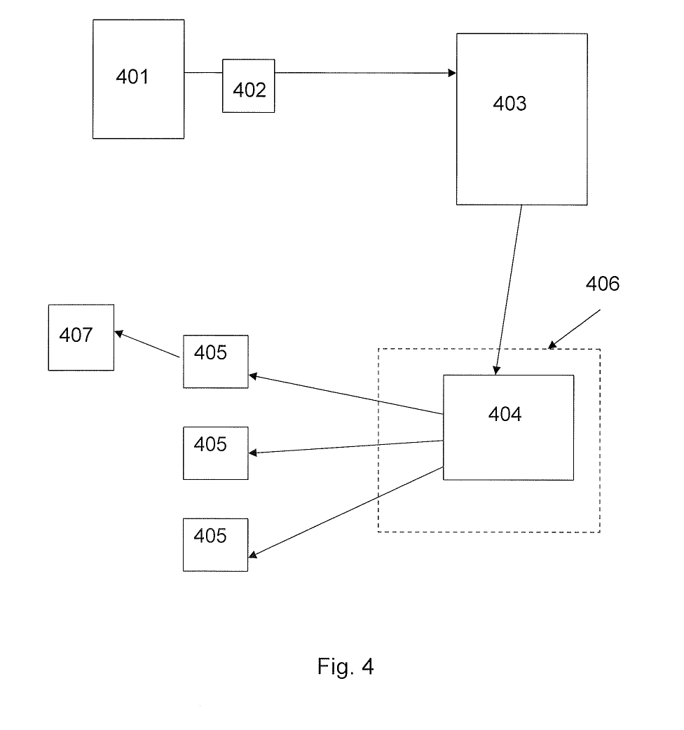

The operation of the system will now be discussed in more detail with respect to different parties in the system (FIG. 4).

The citizen (401) should be equipped with a mobile telephone (402) with a digital camera; advantageously the camera has a flash and good optics. The mobile phone may be for instance a GSM, GPRS, 3G (Europe) or (W)CDMA (USA) compatible phone or similar that enables transmission of multimedia data and/or URL information. Any citizen at the scene of the accident can send an MMS to a designated number or e-mail address connected to the system. The operator will call the citizen on the mobile telephone number that sent the MMS for more verbal details about the accident. A citizen can also call the emergency operator and present the accident to the emergency operator with adequate information. The operator encourages the citizen to send a MMS to a designated number or e-mail address connected to the system. The telephone number with an URL or the e-mail is on a communication infrastructure network (403), which is specifically connected to the Tele-Trauma® (404) at respective emergency operator location. Several overview pictures are taken of the accident scene. One or several photos that best describe the accident are sent as an MMS. The Tele-Trauma® system may receive MMS from mobile telephone numbers or e-mail addresses. Optionally the application has the possibility to not accept MMS from unauthorised mobile phone numbers or e-mail addresses. The ambulance staff or rescue personnel may transfer other information relevant for the accident as well: e.g. medical data, location data, vehicle data, staff data, contact data etc. The citizen may have his camera activated and transmit in real-time with the video camera on the mobile phone.

### Emergency Operator, Emergency Room Staff and Relevant Hospital Staff:

The Tele-Trauma® application (404) fetches the MMS from communication infrastructure network (403) and the recipient, such as the emergency operator or E.R. staff at the user terminal (405) is alerted. The user terminal application (405) of the present invention, e.g. under trademark name Tele-Trauma®, may be opened in any standard web browser on a computer or terminal. Authorised staff is given a category, username and password to the application. The application may be minimized to the taskbar, so other relevant work may be performed on the computer unhindered. Once a photo is sent from an ambulance to Tele-Trauma®, it may pop up from the taskbar and show the received photo with a time stamp and who sent it; this may be performed automatically by the user terminal application (405) or the application may be arranged to alert the user through some alerting mechanism (e.g. a sound and/or light arrangement). The user may invoke displaying the photo on the screen after being alerted.

The photo may be selected and analyzed, e.g. one may double click the thumbnail sized photo on the screen, and it will appear in a new browser window in its original size. The staff examining the picture can use OS (operative system) built in functions (e.g. magnifying glass) or third party functions or programs to analyze the photo further. Other information related to the photo and/or accident may be displayed or at least made available through the user terminal application.

Optionally the photo (or photos) is automatically deleted after 24 hours if it is not saved to the patient journal or archive (407). Only certain categories such as “Administrator” and/or “Doctor” may have full access to data, e.g. saving a photo to a patient's journal. Other categories, such as “others” may have reduced access to the images and data, e.g. only see the picture but not save it.

### Staff on Other Computers and Authorisation:

The application is installed on the hospital server and is accessible through the intranet, thus it can be reached by all the computers on the intranet. Users are given a category with a username and password to log onto the application. For example, the following authorisation categories may be used:

### Administrator:

The Administrator administers the e-mail account and URL from where the Tele-Trauma® may fetch the incoming MMS, the ambulance telephone numbers, staff categories, usernames and passwords. The Administrator has access to logs and can save photos

### Doctor:

The doctor may examine and save photos to the patient journal

### Others:

May only examine photos but not save any

The system (404) is advantageously run with a local server at emergency operator head quarters, hospital premises, or in a secured environment (406) in order to reduce risks for unauthorized access to data. Any type of server application which may receive multimedia data (e.g. images) may be used, for example Microsoft Internet Information Services (IIS) or Microsoft .NET Framework 2.0.

No special database is needed. The files such as log, users and archive may be saved as XML files. However, other database solutions may be used.

Any type of browser (405) compatible computer may be used at the user/client side of the system, for example the Web browser- Microsoft Internet Explorer 5.0 or later is recommended, or Server support for Microsoft .NET Framework 2.0 (if used). However, other web browsers may also work.

The server application may be delivered as computer program product on a computer readable medium or transferred to the server using communication network facilities connected to the server (such as through Ethernet and down loaded through Internet).

For example, a CD with the application binaries may be delivered and the program files may be stored on the network connected secure database server.

The following method may for example be used during the installation process.
1. Create a virtual folder with the name Tele-Trauma that points to a true folder and see to it that the folder is the root for an application. Optionally this folder may contain a web application written in Microsoft .NET v2.0.
2. See that writing properties are accessible for sub folders “Incoming” and “Archive” for the account that is used by asp.net.
3. See that the folder “Gateway.aspx” is accessible from the internet, it must have a public Internet address.
4. A connection between a mobile phone number with a URL and a subscription is established by a serving organisation, or a unique hospital e-mail account is established by the administrator and a connection is created with application.
5. The administrator registers ambulance staff telephone numbers that are unique for an ambulance.
6. The administrator registers and authorises categories for hospital individuals.

Optionally, there is a log(e.g. in the server) that logs relevant information with a time stamp, said relevant information may comprise:
who accesses the application.
the authorised ambulance personnel who are sending photos.
mobile numbers who are not authorised tries to send a photo.
who stores or moves received picture.
Optionally a port to the internet needs to be open in the firewall, e.g. port 80 or 70.
Incoming pictures may be in any suitable file format, but the format is advantageously in a compressed storage format such as JPG.
No Active X-components are needed.
Preferably the application fetches incoming MMS from the e-mail account and the URL automatically every 30 seconds, and simultaneously it deletes the MMS from the e-mail account, avoiding stored MMS. The e-mail account may be considered passive.

A method for fetching data will now be described:
1. Static (or passive) e-mail account is created or/and connected to an URL
2. The application accepts any MMS that is sent to the right e-mail or URL. An option in the application is that the administrator can prohibit and authorize specific mobile telephone numbers and e-mails.
3. Application located e.g. at emergency operator or at the hospital fetches all Digital medium sent to the e-mail address and erases them from the e-mail account.
4. The application accepts all national telephone numbers and all e-mail addresses.
5. An option for the application is to only accept “authorized” telephone numbers or e-mail addresses to “enter” the application. Unauthorized telephone numbers and e-mails are not delivered, but optionally a log is created that shows which e-mail or telephone number tried to send a digital medium to the application

All mobile traffic is normally encrypted: GSM 128 bits and 3G 256 bits (Reference GSM Security and Encryption by David Margrave, George Mason University) which forms part of the security handling of multimedia information in the system. It is also illegal to eavesdrop on telephone lines in most countries.

It is recommended that the photo taken at an accident is an overview, where individuals can not be identified directly. If photos are stored in a patient journal, the law concerning patient journals is applied.

All incoming photos may be stored in the application for a predetermined period of time, e.g. for a maximum of 24 hours and are thereafter automatically erased. If photos are actively saved by emergency operator or hospital personnel it should be in accordance to guidelines.

Logs can be used as a security measure to identify any misuse or error application search. Even non authorised telephone numbers that try to send an MMS are logged.

The administrator has access to all log history.

Preferably all received photos receive a watermark “Tele-Trauma” as a security measure.

### Installation and Use of Tele-Trauma® Method:

1. Tele-Trauma® is installed on server
2. Administrator configures either e-mail solution or mobile number subscription with URL
3. Administrator configures ambulance mobile phone numbers & staff usernames, password and category
4. Citizens or ambulance personnel send MMS to either e-mail solution or mobile number subscription in point 2.
5. Tele-Trauma® fetches MMS from either e-mail solution or mobile number subscription in point 2.
6. Staff who are logged on to Tele-Trauma® can see incoming MMS sent from ambulance
7. MMS is stored for max 24 h on application, then is automatically deleted by Tele-Trauma® if not saved to patient journal

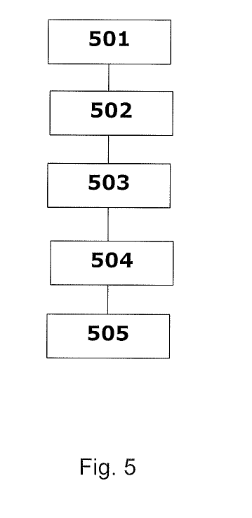

FIG. 5 illustrates schematically a typical use of the present invention:

501. A citizen or emergency personnel take a photo at an accident scene and send the photo to a server;
502. The photo is received and stored by the server;
503. The server sends a command to a user terminal;
504. The user terminal receives the command and alerts a user of an incoming photo;
505. The user terminal displays the photo together with any information relevant for the photo.

It should be noted that the present invention has been exemplified using Microsoft server applications and Microsoft .NET application, but the invention is not limited to these but any other suitable server and server application may be used that enables receiving incoming multimedia messages and handling of users to database.

Furthermore it should be noted that the word “comprising” does not exclude the presence of other elements or steps than those listed and the words “a” or “an” preceding an element do not exclude the presence of a plurality of such elements. It should further be noted that any reference signs do not limit the scope of the claims, that at least parts of the invention may be implemented by means of both hardware and software, and that several “means”, “units” and “devices” may be represented by the same item of hardware.

The above mentioned and described embodiments are only given as examples and should not be seen to be limiting to the present invention. Other solutions, uses, objectives, and functions within the scope of the invention as claimed in the below described patent claims should be apparent for the person skilled in the art.

1. A system facilitating communication when diagnosing skin conditions, comprising:
a server arranged to receive a multimedia message, MMS, from a mobile phone and store the MMS file in a database;
an operator interface in communication with the server, arranged to provide access to the database and to receive diagnosis information from an operator relating to the stored MMS file;
wherein the server is further arranged to transmit a short message back to the mobile phone with the information received from the operator.

2. The system according to claim 1, wherein the server is further arranged to provide charging of transmittal of short message back to the mobile phone.

3. The system according to claim 1, wherein the server is further arranged to receive information about the user of the mobile phone.

4. The system according to claim 3, wherein the information about the user comprise at least one of a unique errand number, a name, address, and a social security number.

5. A method for handling communication of skin condition diagnosis, comprising the steps of:
receiving in a server from a mobile phone a multimedia message, MMS, with at least one image of a skin condition to be diagnosed;
storing the MMS in a database;
providing anonymity for the client using a unique errand number for every unique MMS;
providing access to the database for a medical staff;
receiving on a user interface a diagnosis from the medical staff relating to the skin condition;
storing the diagnosis in the server;
transmitting a message relating to the diagnosis back to the mobile phone.

6. The method according to claim 5, further comprising a step of transmitting a prescription relating to the skin condition to a pharmacy together with information relating to a user of the mobile phone.

7. The method according to claim 6, wherein the information relating to the user is at least one of a unique errand number, a name, address, and a social security number.

8. The method according to claim 5, further comprising a step of charging the mobile phone for the transmittal of message relating to the diagnosis.

9. A device for facilitating communication when diagnosing a skin condition, comprising:
a processor;
a memory; and
a communication interface;
wherein the processor is arranged to receive on the communication interface from a mobile phone a multimedia message, MMS, with at least one image of a skin condition to be diagnosed, storing the MMS in a database in the memory, returning a SMS to the sender with a unique random errand number for every unique MMS, providing access to the database, and to receive diagnosis information from an operator relating to the stored MMS file, wherein the processor is further arranged to transmit on the communication interface a short message or multimedia message back to the mobile phone with the information received from the operator.
